(19) United States
(12) Patent Application Publication
(10) Pub. No.: US 2025/0018487 A1
(43) Pub. Date: Jan. 16, 2025

(54) ELECTRODE WIRE

(71) Applicant: THERMOCOMPACT, Epagny Metz-Tessy (FR)

(72) Inventors: Michel Ly, Epagny Metz-Tessy (FR); Pierro Cadio, Epagny Metz-Tessy (FR)

(21) Appl. No.: 18/710,737

(22) PCT Filed: Sep. 29, 2022
(86) PCT No.: PCT/EP2022/077240

§ 371 Date: May 16, 2024

(30) Foreign Application Priority Data
Nov. 16, 2021 (FR) FR2112096

(51) Int. Cl. B23H 7/08; C22C 9/04; C22C 18/02; C25D 5/50

(52) U.S. Cl. CPC B23H 7/08; C22C 9/04; C22C 18/02; C25D 5/50

(57) ABSTRACT

An electrode wire, for electrical discharge machining, includes a metal core, and, on the metal core, a coating including one or more textured zones of copper-zinc alloy. Each of these textured zones is formed solely of an entanglement of copper-zinc gamma phase alloy and copper-zinc epsilon phase alloy. Inside each textured zone of copper-zinc alloy, the majority of the copper-zinc gamma phase alloy has a lamellar texture in which the spaces between the strips of copper-zinc gamma phase alloy are filled with the copper-zinc epsilon phase alloy.

### CROSS REFERENCE TO RELATED APPLICATIONS

This application is a national phase entry under 35 U.S.C. § 371 of International Patent Application PCT/EP2022/077240, filed Sep. 29, 2022, designating the United States of America and published as International Patent Publication WO 2023/088602 A1 on May 25, 2023, which claims benefit, under Article 8 of the Patent Cooperation Treaty, to French Patent Application Serial No. FR2112096, filed Nov. 16, 2021.

### TECHNICAL FIELD

The disclosure concerns an electrode wire for electrical discharge machining and a method of manufacturing the electrode wire.

### BACKGROUND

Electrode wires are used to cut metals or electrically conductive materials by electrical discharge in an electrical discharge machining machine.

The well-known method of electrical discharge machining, also known as spark erosion machining, enables removal of material from an electrically conductive part by generating sparks in a machining zone between the part to be machined and an electrically conductive electrode wire. The electrode wire is fed continuously in the vicinity of the part in the lengthwise direction of the wire, held by guides, and is moved progressively in the transverse direction toward the part, either by transverse movement in translation of the wire guides or by movement in translation of the part.

An electrical generator connected to the electrode wire by electrical contacts outside the machining zone establishes an appropriate potential difference between the electrode wire and the conductive part to be machined. The machining zone between the electrode wire and the part is immersed in an appropriate dielectric fluid. The potential difference causes sparks to appear between the electrode wire and the part to be machined that progressively erode the part and the electrode wire. The longitudinal movement of the electrode wire enables a wire diameter sufficient to prevent it breaking in the machining zone to be maintained continuously. The relative movement of the wire and the part in the transverse direction enables the part to be cut or its surface to be treated, where necessary.

The particles detached from the electrode wire and from the part by the sparks are dispersed in the dielectric fluid, from which they are evacuated.

Obtaining machining precision, in particular producing angle cuts with a small radius, necessitates the use of wires of small diameter and withstanding a high mechanical load at rupture to be tensioned in the machining zone and limitation of the amplitude of vibrations.

Most modern electrical discharge machining machines are designed to use metal wires generally with a diameter of 0.25 mm and an ultimate tensile strength between 400 N/mm² and 1 000 N/mm² inclusive.

When a spark is produced between the electrode wire and the part the surface of the electrode wire is suddenly heated to a very high temperature for a short time. As a result of this the material of the superficial layer of the electrode wire at the location of the spark goes from the solid state to the liquid or gas state and is moved on the surface of the electrode wire and/or evacuated into the dielectric liquid. It is found that the exterior face of the electrode wire reached by the spark has been deformed, generally assuming a slightly concave crater shape, with zones in which the material has been melted and resolidified.

It has been found that the efficacy of the electrical discharge sparks is greatly dependent on the nature and the topography of the surface layer of the electrode wire. Considerable progress in electrical discharge efficacy has been made here by using electrode wires including:
a core made of one or more metals or alloys assuring good conduction of the electrical current and good mechanical strength to withstand the mechanical tensile load on the wire, and
a coating of one or more other metals or alloys and/or a particular topography, for example fractures, assuring better electrical discharge efficacy, for example a higher speed of erosion.

For example, U.S. Pat. No. 8,067,689 describes an electrode wire having a brass core covered by a layer of copper-zinc alloy. In that disclosure, the layer of copper-zinc alloy includes a mixture of gamma phase copper-zinc alloy and epsilon phase copper-zinc alloy.

This particular coating structure generally aims for faster electrical discharge machining of a part.

Also known in the prior art are:
JP3090009B2, and
MA D et al.: “Unidirectional solidification of Zn-rich Zn—Cu peritectic alloys-I. Microstructure selection,” ACTA MATERIALIA, Elsevier, Oxford, vol. 48, No. 2, 24 Jan. 2000, pp. 419-431.

However, there remains a need to increase the speed of electrical discharge machining for a given electrical spark intensity.

### BRIEF SUMMARY

This disclosure aims to meet the above-discussed needs by proposing an electrode wire conforming to claim(s) herein.

Another object of the disclosure is a method of manufacturing the claimed electrode wire.

### BRIEF DESCRIPTION OF THE DRAWINGS

This disclosure will be better understood after reading the following description given by way of non-limiting example only and with reference to the drawings, in which:

FIG. 1 is a schematic depiction of the cross section of an electrode wire;

FIG. 2 is a schematic depiction in cross section and to a larger scale of a portion of a lamellar texture of a layer of the electrode wire of FIG. 1;

FIG. 3 is a schematic depiction to an even larger scale of a part of the lamellar texture of FIG. 2;

FIG. 4 is a black and white photograph of the lamellar texture from FIG. 2; and

FIG. 5 is a flowchart of a method of manufacturing the electrode wire of FIG. 1.

### DETAILED DESCRIPTION

In the figures the same references are used to designate the same elements. In the remainder of this description features and functions well known to the person skilled in the art are not described in detail.

Hereinafter, in Chapter I, definitions are given of certain terms. In Chapter II, detailed exemplary embodiments are described with reference to the figures. Then, in Chapter III, variants of these embodiments are described. Finally, in Chapter IV, the advantages of the various embodiments are described.

### Chapter I: Definitions and Terminology

The expression “element made of material A” designates an element in which the material A represents at least 90 wt % of that element and, preferably, at least 95 wt % or 98 wt % of that element.

The expression “copper-zinc alloy” designates an alloy formed exclusively of copper and zinc apart from inevitable impurities.

A “phase” of the copper-zinc alloy designates a solid phase of the copper-zinc alloy that has a particular crystallographic structure. To be more precise the phases of the copper-zinc system differ from one another by their composition and by their particular crystallographic structure. This particular crystallographic structure enables a phase of the copper-zinc alloy to be distinguished from a simple mixture of fine grains of copper and zinc having the same overall composition. Known phases of the copper-zinc alloy are typically the alpha phase, the beta phase, the gamma phase, the delta phase, the epsilon phase and the eta phase. The particular crystallographic structure of a phase can be identified by various means. For example, optical or metallographic microphotographs of polished samples show shades of different colors for each phase, provided that the sample has been chemically treated appropriately. Thus, to distinguish the gamma phase from the epsilon phase, chemical treatment with “Nital” is used, which is a solution of 3% nitric acid diluted in ethanol. The gamma phase then appears gray while the epsilon phase appears brown. It is also possible to distinguish the gamma phase from the epsilon phase by observing the sample under a scanning electron microscope using the backscattered electron detector. It is also possible to identify the phase of a sample by X-ray diffraction. In this case the sample of wire is placed under an incident beam of X-rays with a precise wavelength. The Kα line of copper is used, for example, with a wavelength of 0.1541 nm. The intensity of the diffracted rays is evaluated for each diffraction angle. The gamma phase has a known X-ray diffraction spectrum different from that of the other phases of the copper-zinc system and from the zinc oxide ZnO often found on the surface of the wires. If the copper-zinc alloy has not crystallized in the form of at least one of the alpha, beta, gamma, delta, epsilon or eta phases it is amorphous and the X-ray diffraction spectrum then shows flattened humps rather than projecting peaks.

At a given temperature the various phases of the copper-zinc alloy each correspond to a specific range of zinc concentration. The extent of each of these specific ranges of zinc concentration varies as a function of temperature. The zinc concentration of a phase of a sample can be obtained by composition microanalysis. A composition microanalysis is carried out using a scanning electron microscope equipped with a spectrometry probe. A beam of electrons accelerated, for example, in a 20 kV electrical field impacts the surface of the sample and causes emission of X-rays. The X-rays have an energy spectrum characteristic of the composition of the surface of the sample that the electron beam has impacted. The spectrum of the X-rays emitted by the surface of the sample is measured using an energy dispersion spectrometry (EDS) analysis probe or a wavelength selection (WDS) analysis probe. Algorithms enable selection of the elements analyzed (and thus elimination of the effect of impurities) and calculation of the composition of the sample the electron beam has impacted based on the measured spectra. It should be noted that because of the interactions between the X-rays and the material the volume analyzed by EDS (or WDS) analysis is generally approximately one cubic micrometer. At the frontier between two phases a mean concentration that does not exist in reality in either of the two phases can be measured. The concentrations indicated here concern pure phases in their analysis volume except in the case of structured zones. The zones in which concentration is measured are larger than cubes with a side length of one micrometer.

The delta phase of the copper-zinc alloy is particular in that it exists in the stable state only between 559° C. and 700° C. It does not exist in the stable state at ambient temperature. The crystallographic structure of the delta phase of the copper-zinc system in its stable state at a temperature of 600° C. was published in 1971 by J. Lenz and K. Schubert in Zeitschrift für Metallkunde vol. 62, pages 810-816.

The expression “electrical conductor” designates a material the electrical conductivity of which at 20° C. is greater than 106 S/m and preferably greater than 10⁷ S/m.

The longitudinal axis of a wire is the axis along which the wire mainly extends.

The expression “cross section” designates a section of the electrode wire perpendicular to its longitudinal axis.

The expression “layer of the electrode wire” designates an annular layer of the electrode wire that in each cross section of the electrode wire is situated between an interior circular limit and an exterior circular limit. In reality these limits are not perfect circles. However, and to a first approximation, in the present text these limits are treated as circles. Both these circular limits are centered on the axis of the electrode wire. The interior circular limit is the limit of the layer that is nearest the axis of the electrode wire. Conversely, the exterior circular limit is the limit of the layer that is farthest from the axis of the electrode wire. Between these interior and exterior circular limits, the phase of the copper-zinc alloy is homogeneous or formed of an irregular entanglement of various phases of the copper-zinc alloy. Conversely, at the level of the interior and exterior circular limits the chemical composition and/or the crystallographic form suddenly change(s).

The expression “entanglement of different phases” of the copper-zinc alloy designates a mixture of different phases of the copper-zinc alloy in which the different phases are not each disposed in a respective homogeneous layer. In other words, moving along a circle that is centered on the longitudinal axis of the wire and that crosses this entanglement of phases one phase and then another are alternately encountered and this is repeated several times.

A “homogeneous” layer is a layer formed of a single phase of the copper-zinc alloy.

The expression “uniform layer” designates a layer formed of a material that, in a cross section of the wire, extends around the axis of the wire and inside this layer continuously or practically continuously. Accordingly, a uniform layer does not include a multitude of fractures that divide it into a multitude of zones separated from one another in a cross section of the wire by very numerous radial fractures. By very numerous radial fractures is meant more than about ten radial fractures that divide the layer in question into about ten zones mechanically isolated from one another in the cross section by the radial fractures.

Conversely, the expression “fractured layer” designates a layer that includes a multitude of fractures that divide it into a multitude of zones separated from one another in a cross section of the wire by very numerous radial fractures.

The expression “metal surface layer,” or simply “surface layer,” designates the layer of copper-zinc alloy or zinc of the electrode wire that is the outermost layer of the electrode wire. The metal surface layer may have on its surface a thin film of oxide. This oxide film is typically made up mainly of zinc oxide, zinc hydroxides, zinc carbonate and possible residues such as wire drawing lubricant residues. The exterior face of this metal surface layer is therefore either coincident with the exterior face of the electrode wire in the absence of the fine oxide film or separated from the exterior face of the electrode wire exclusively by the fine oxide film.

A “radial fracture” is a fracture that extends mainly in a radial direction in a cross section of the electrode wire.

The expression “ambient temperature” designates a temperature between 15° C. and 30° C. inclusive and typically equal to 25° C.

A “median trajectory of an elongate element” is the trajectory along which the elongate element mainly extends. In a cross section of the electrode wire this median trajectory is located in the middle of the thickness of the elongate element. In other words, the cross section of the elongate element is centered on the median trajectory. Accordingly, in a cross section the area of the elongate element situated on one side of its median trajectory is equal to the area of the elongate element situated on the other side of the median trajectory.

The mean thickness of an elongate element along its median trajectory is equal to the mean value of the thickness of the elongate element measured at each point of its median trajectory. At each of the points of the median trajectory the thickness is measured in a direction perpendicular to the median trajectory and contained in the plane of the cross section.

### Chapter II: Exemplary Embodiments

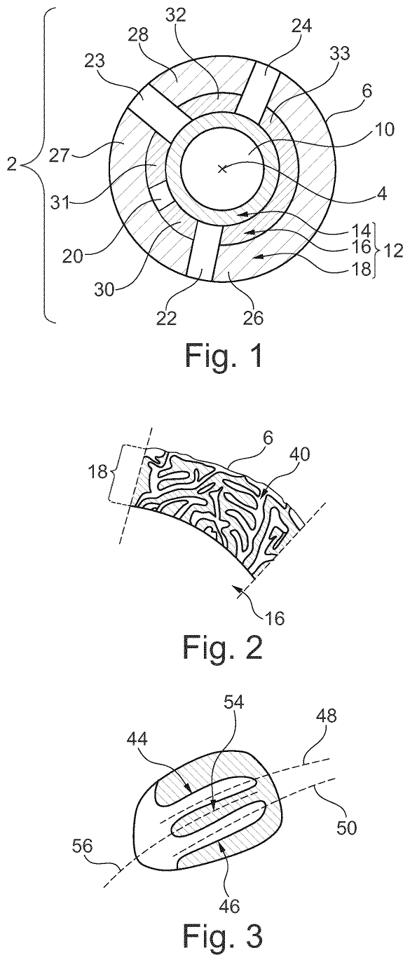

FIG. 1 represents an electrode wire 2 (also referred to herein as a “wire” 2) for electrical discharge machining as described in the introductory part of the present text.

To this end the electrode wire 2 has an ultimate tensile strength between 400 N/mm² and 1 000 N/mm² inclusive. The wire 2 extends along a longitudinal axis 4. Here the axis 4 is perpendicular to the plane of the drawing. The length of the wire 2 is greater than 1 m and typically greater than 10 m or 50 m.

The wire 2 has an exterior face 6 directly exposed to the sparks when machining a part by electrical discharge machining using the wire. The exterior face 6 is a cylindrical face that extends along the axis 4. The directrix curve of the face 6 is mainly a circle centered on the axis 4. The cross section of the wire 2 is therefore circular. The outside diameter D₂ of the wire 2 is typically between 50 μm and 1 mm inclusive and most often between 70 μm and 400 μm inclusive. Here the diameter of the wire 2 is equal to 250 μm.

In this embodiment the wire 2 includes:
a central core 10 (also referred to herein as a “core” 10) made of an electrically conductive material; and
a coating 12 deposited directly on the core 10.

The function of the core 10 is to assure, on its own, the greater part of the ultimate tensile strength of the wire 2. It also has the function of assuring the electrical conductivity of the wire 2. To this end it is made of an electrically conductive material. It is typically made of a metal or a metal alloy. For example, in this embodiment, the core 10 is made of copper.

The diameter D₁₀ of the core 10 is between 0.75 D₂ and 0.98 D₂ inclusive and typically between 0.85 D₂ and 0.95 D₂, where D₂ is the outside diameter of the electrode wire 2. For example, here the diameter D₁₀ is equal to 230 μm.

The coating 12 is designed to increase the speed of machining and therefore the erosive yield of the electrode wire and/or the quality of the faces of the part obtained after the electrical discharge machining. The quality of a face cut by electrical discharge machining increases as its roughness decreases.

The thickness of the coating 12 is small compared to the diameter D₂ of the wire 2, that is to say less than 10% of the diameter D₂ and preferably less than 8% of the diameter D₂. The thickness of the coating 12 corresponds to the shortest distance in a cross section between the exterior face 6 and the circular limit that separates the core 10 from the coating 12.

In this embodiment, the coating 12 is formed of three layers 14, 16 and 18 stacked directly and successively on one another from the axis 4 to the exterior face 6. The thickness of the layer 18 is typically greater than 1% or 2% of the diameter D₂. For example, the thickness of the layer 18 is at least greater than 2 μm or 5 μm or 10 μm. The thickness of the other layers 14 and 16 is preferably less than the thickness of the layer 18. For example, here the thicknesses of the layers 14 and 16 are respectively less than 5 μm and less than 10 μm.

The layer 14 is a homogeneous and uniform layer of beta phase copper-zinc alloy. The zinc concentration is therefore typically between 45 atomic percent and 50 atomic percent inclusive, the remainder being copper and inevitable impurities.

The layer 16 is a homogeneous layer of gamma phase copper-zinc alloy. The zinc concentration is typically between 62 atomic percent and 71 atomic percent inclusive, the remainder being copper and inevitable impurities. For example, here, the zinc concentration is 64 atomic percent.

It follows from the phase equilibrium diagram of the copper-zinc system as recently updated that, in a stable state, the gamma phase copper-zinc alloy has a zinc concentration that is between 60 atomic percent and 62 atomic percent inclusive at ambient temperature, the remainder being copper. A recently updated phase equilibrium diagram of the copper-zinc system has been published in the following paper, for example: Liang et al.: “Thermodynamic assessment of the Al—Cu—Zn system, part I: Cu—Zn binary System,” CALPHAD, volume 51, 2015, pages 224 to 232.

Accordingly, with a zinc concentration of 64% the gamma phase copper-zinc alloy of the layer 16 is not in a stable state at ambient temperature. Here it is in a metastable state. In a metastable state the transformation of the gamma phase copper-zinc alloy to its stable state and thus the decrease in its zinc concentration is very slow at ambient temperature. In other words, this transformation from the gamma phase to its stable state at ambient temperature is practically imperceptible for a human being. Accordingly, the composition of this gamma phase in its metastable state hardly varies from its manufacture to its arrival in a machining zone of an electrical discharge machining machine when the wire 2 is stored and transported under normal conditions and thus maintained at ambient temperature. A method of manufacturing such a metastable copper-zinc alloy layer is described below.

The layer 18 is a textured superficial layer of copper-zinc alloy. To be more precise, in each cross section the layer 18 is here formed mainly of a plurality of textured zones. Each of the textured zones is formed exclusively by an entanglement of gamma phase copper-zinc alloy and epsilon phase copper-zinc alloy. The entanglement is described in more detail with reference to FIGS. 2 and 3 below.

In the layer 18 the zinc concentration in each of the textured zones is greater than 72 atomic percent or 73 atomic percent and less than 80 atomic percent. Here the zinc concentration of the textured zones of the layer 18 is equal to 74 atomic percent, the remainder being copper and impurities. The thickness of the layer 18 is advantageously greater than 10% or 20% or 30% of the total thickness of the coating 12.

In this embodiment the layers 16 and 18 are fractured. Thus, the layers 16 and 18 include fractures that divide each of these layers into a plurality of zones mechanically separated from one another in a cross section by fractures. As described below these fractures are obtained by drawing a wire in which the layers 16 and 18 are uniform or practically uniform. After drawing the same material no longer extends continuously all around the axis 4 but is divided into a plurality of zones of material that in a cross section are mechanically separated from one another by fractures or cracks. The fractures extend mainly radially and cross the layer 16 and/or the layer 18 completely.

To be more precise, it has been observed that there mainly exist two different types of fracture in the electrode wire 2. The first type of fracture consists of fractures that extend exclusively inside the layer 16. This first type of fracture does not extend across the layer 18, that is to say does not cross the layer 18 completely. In FIG. 1 the reference number 20 designates a diagrammatic depiction of a fracture of the first type. The fracture 20 extends from the circular limit that separates the layers 14 and 16 to the circular limit that separates the layers 16 and 18. The fracture 20 does not extend inside the layers 14 and 18.

The second type of fracture consists of fractures that extend across both layers 16 and 18. The second type of fracture typically originates at the level of the circular limit between the layers 14 and 16 and is extended as far as the exterior face 6. It is only this second type of fracture that divides the layer 18 into a plurality of distinct zones.

In FIG. 1 three fractures 22 to 24 of the second type are represented schematically. These three fractures 22 to 24 divide the layer 18 into three distinct zones 26 to 28. Together with the fractures of the first type the fractures of the second type contribute to dividing the layer 16 into a plurality of distinct zones. In FIG. 1 the fractures 20 and 22 to 24 divide the layer 16 into four distinct zones 30 to 33.

Whether they are fractures of the first type or of the second type, the fractures correspond to recesses or hollows containing no solid or liquid material. The width of a fracture in a direction perpendicular to the radial direction along which it extends is generally less than 2 μm.

The greatest width in cross section of each of the textured zones is typically greater than the thickness of the layer 18. Here this greatest width is greater than 5 μm or 10 μm. In the present text the width of a textured zone in a cross section is defined as being equal to the length of the side of the smallest area rectangle that contains the textured zone entirely and at least one of the sides of which is perpendicular to a radial line passing through this textured zone and contained within the cross section. The radial line is that which passes through the axis 4 and divides into two equal parts the smallest angular sector that contains entirely the textured zone in the cross section and the apex of which is on the axis 4. The side of the rectangle the length of which is measured is that which is perpendicular to the radial line.

FIG. 2 represents an enlargement of the cross section of a lower portion of a textured zone of the layer 18. FIG. 3 represents a portion to an even larger scale of one of these textured zones. In each textured zone the gamma phase copper-zinc alloy has a mainly lamellar texture 40 (FIG. 2) and the epsilon phase copper-zinc alloy fills the interstices between the lamellae of the lamellar texture 40. The lamellar texture 40 is represented in white in FIGS. 2 and 3 while the epsilon phase copper-zinc alloy is cross-hatched in the same figures.

The weight of the lamellar texture 40 typically represents more than 80% and generally more than 90% or 95% of the weight of the gamma phase copper-zinc alloy contained in the layer 18.

As explained below, the lamellar texture 40 is obtained here by interrupting before it is completely finished the transformation of a delta phase copper-zinc alloy layer into a homogeneous lower sub-layer of gamma phase copper-zinc alloy possibly surmounted by a homogeneous sub-layer of epsilon phase copper-zinc alloy.

The lamellar texture 40 is formed of numerous elongate lamellac that in a cross section each extend mainly along a respective median trajectory. For example, FIG. 3 represents two lamellae 44 and 46 of the lamellar texture 40 each of which extends along a respective median trajectory 48 or 50.

In the great majority of cases the lamellae extend several micrometers and so their median trajectory is several micrometers long. The median trajectory along which a lamella extends is often curved or sinuous.

In most cases, in each cross section one of the ends of a lamella is mechanically connected directly to another lamella. The lamellar texture 40 therefore forms in each cross section a tree structure containing a multitude of paths that extend continuously from the layer 16 to the exterior face 6. The other end of the lamella is either free, that is to say not mechanically connected directly to another lamella, or also mechanically connected directly to another lamella.

For most of the lamellae and generally more than 80% or 90% or 95% of the lamellae of the lamellar texture 40 the mean thickness of the lamella along its median trajectory is less than 1 μm or 0.5 μm. Also, the mean thickness of the lamellae along their median trajectories is generally greater than 0.1 μm.

Given that the lamellae are elongate, most and typically more than 80% of the interstices between the lamellae are also elongate. To be more precise, the interstices situated between the lamellae each also extend mainly along a respective median trajectory. FIG. 3 represents one such interstice 54 that is situated between the two lamellae 44 and 46 and extends along a median trajectory 56.

The mean thickness of the elongate interstices along their respective median trajectories is less than 1 μm or 0.5 μm in more than 50% of cases and most often in more than 80% of cases. This mean thickness is also generally greater than 0.1 μm.

In FIG. 3, to render the median trajectory of an elongate element more visible this median trajectory has been extended on each side beyond the elongate element. However, in reality each median trajectory begins at one end of the elongate element and ends at its opposite end.

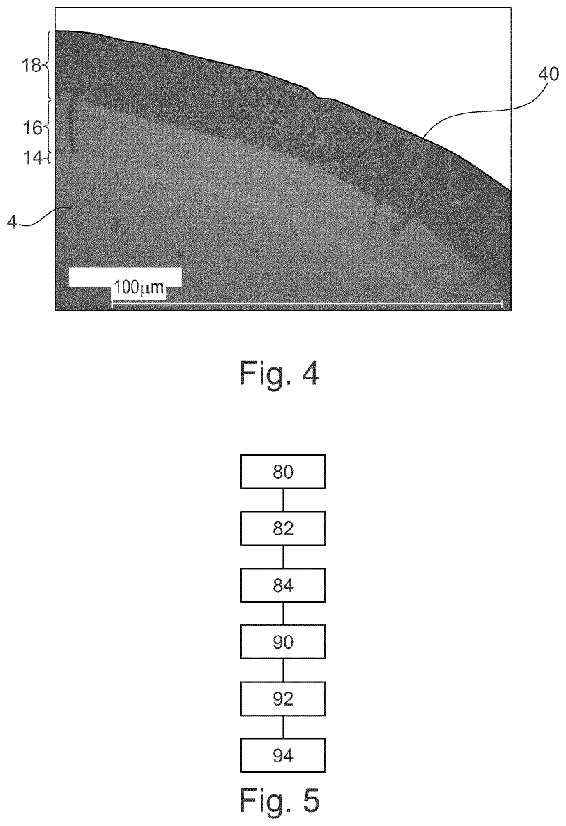

FIG. 4 represents a portion of a textured zone obtained by observing the cross section of the wire 2 using an optical microscope. In this photograph in the layer 18 the gamma phase copper-zinc alloy lamellae that form the lamellar texture 40 are colored white while the epsilon phase copper-zinc alloy that fills the interstices between the lamellae is colored black. In this photograph the cross section observed is that of the electrode wire just before it undergoes a wire drawing operation and therefore before most of the fractures of the first and second type are created. However, as can be seen, for example, in the part of the layer 16 situated top left, the layer 16 may include fractures of the first type even before execution of this wire drawing operation.

A method for manufacturing the wire 2 is described next with reference to the method of FIG. 5.

During a step 80, a metal wire blank is first obtained. In this example the wire blank is a copper wire with a diameter of 1 mm.

Then, during a step 82, a coating is produced on the wire blank. This coating continuously covers the entirety of the exterior face of the wire blank. This coating is made of a material or a plurality of materials having the capacity to form a delta phase copper-zinc alloy surface layer when its temperature is between 559° C. and 700° C. This range of temperatures corresponds to the range of temperatures within which the delta phase copper-zinc alloy is stable. Outside this range of temperatures, the delta phase is not stable. In particular, if the temperature falls below 559° C. the delta phase decomposes spontaneously on the one hand into gamma phase copper-zinc alloy and on the other hand into epsilon phase copper-zinc alloy. Thus, if no particular heat treatment is carried out, for example if the delta phase copper-zinc alloy layer is merely cooled in air at ambient temperature, the delta phase copper-zinc alloy layer decomposes into a homogeneous sub-layer of gamma phase copper-zinc alloy surmounted by a homogenous sub-layer of epsilon phase copper-zinc alloy. In this example at this stage the coating is formed only by a layer of zinc deposited directly onto the exterior face of the wire blank. To this end the layer of zinc is deposited on the wire blank by an electrolytic zinc plating process to obtain a wire electroplated with zinc with a diameter greater than 1 mm.

Here, at the end of step 82, the wire electroplated with zinc is drawn until its diameter is equal to 420 μm. At this stage, the thickness of the zinc coating is equal to 25 μm.

During a step 84, the temperature of the zinc coating is then raised to a temperature Tᵢₙᵢ between 559° C. and 700° C. inclusive and preferably between 559° C. and 600° C. inclusive and even more advantageously between 595° C. and 600° C. inclusive. Choosing a temperature Tᵢₙᵢ below or equal to 600° C. makes it possible to limit the formation of droplets of molten zinc during heating. Here the temperature Tᵢₙᵢ is equal to 600° C.

For example, during step 84, the drawn electrically zinc-plated wire is introduced into a furnace the interior temperature of which is equal to 600° C. This heat treatment is carried out in air.

During step 84, the drawn electrically zinc-plated wire is maintained at the temperature Tᵢₙᵢ for a duration dᵢₙᵢ sufficiently long for a surface layer of delta phase copper-zinc alloy at least 4 μm thick to form. Here the duration dᵢₙᵢ is also chosen to be sufficiently short to prevent the formation of an epsilon phase copper-zinc alloy layer on top of the delta phase copper-zinc alloy layer. In fact, as taught in U.S. Pat. No. 5,762,726 A, at this temperature Tᵢₙᵢ the copper diffuses progressively into the zinc coating. Accordingly, at a given location of the initially zinc coating, the copper concentration increases progressively with time.

Furthermore, given that the copper diffuses into the coating by moving from the copper wire blank to the exterior of the wire a copper concentration gradient exists within the thickness of the coating. The copper concentration inside the coating decreases progressively from the wire blank to the exterior. Conversely, the zinc concentration increases in the direction toward the exterior face of the wire. Because of this copper concentration gradient, during step 84, a plurality of stacked copper-zinc alloy layers with the various phases appears. In these stacked copper-zinc alloy layers the layers are in order of increasing zinc concentration on approaching the exterior face. The surface layer of copper-zinc alloy is therefore always that in which the zinc concentration is the highest.

Here, the objective of step 84 is to form a surface layer of delta phase copper-zinc alloy. At the temperature Tᵢₙᵢ the delta phase of the copper-zinc alloy appears when the zinc concentration is between 72 atomic percent and 77 atomic percent inclusive, the remainder being copper.

Here the duration dᵢₙᵢ is therefore chosen to be sufficiently long to allow sufficient time for the quantity of copper that diffuses as far as the surface layer to be sufficiently large to cause the zinc concentration inside the surface layer to fall to between 72 atomic percent and 77 atomic percent. At the temperature Tᵢₙᵢ and for as long as the zinc concentration of the surface layer is between 72 atomic percent and 77 atomic percent inclusive the copper-zinc alloy in this layer is in the delta phase.

If the chosen duration dᵢₙᵢ is too short the surface layer is a layer of epsilon phase copper-zinc alloy because the zinc concentration has not decreased significantly to enable formation of the delta phase of that alloy. To the contrary, if the duration dᵢₙᵢ is chosen to be too long the zinc concentration inside the surface layer falls below 72 atomic percent. A surface layer of gamma phase copper-zinc alloy or even of beta phase copper-zinc alloy is then obtained, for example.

Based on these explanations the duration dᵢₙᵢ is determined by successive experiments. In the case described here, for example, the duration dᵢₙᵢ is equal to 6 s.

At the end of the duration dᵢₙᵢ the coating deposited on the copper wire blank is made up of a layer of beta phase copper-zinc alloy on top of which is a gamma phase copper-zinc alloy layer on top of which is a delta phase copper-zinc alloy surface layer.

As soon as the delta phase surface layer is obtained, that is to say here immediately at the end of the duration dᵢₙᵢ, the wire undergoes successively a first step 90 of slow cooling immediately followed by a second step 92 of rapid cooling.

During step 90, the wire is cooled sufficiently slowly to maintain the temperature of the surface layer below 559° C. and above a temperature T₉₀ₘᵢₙ for a duration d₁ between d₁ₘᵢₙ and d₁ₘₐₓ inclusive. The temperature T₉₀ₘᵢₙ is greater than or equal to 350° C. and preferably greater than or equal to 400° C. or to 500° C.

The duration d₁ₘᵢₙ is the minimum duration for which the temperature of a delta phase copper-zinc alloy must be kept below 559° C. so that:
some of the delta phase copper-zinc alloy is transformed into gamma phase copper-zinc alloy and forms a gamma phase copper-zinc alloy lamellar texture that contains the majority of the gamma phase copper-zinc alloy; and
in parallel with the above the rest of the delta phase copper-zinc alloy is transformed into epsilon phase copper-zinc alloy that fills the interstices between the lamellae of the gamma phase copper-zinc alloy lamellar texture.

The duration d₁ₘₐₓ is the shortest duration beyond which the copper-zinc alloy lamellar texture disappears to give way to a sub-layer 90% by weight of which is formed by gamma phase copper-zinc alloy.

It has been observed that the duration d₁ is generally between 0.1 s and 1.5 s inclusive. To maintain the temperature of the surface layer between 559° C. and 350° C. it is therefore necessary for the speed of cooling during step 90 to be less than 2 100° C./s. During step 90 the speed of cooling is preferably less than 1 000° C./s or less than 400° C./s. Here, during step 90, the wire is cooled by removing it rapidly from the furnace and placing it in air at ambient temperature throughout the duration d₁. The speed of cooling in air at ambient temperature is generally between 50° C./s and 200° C./s and often close to or equal to 100° C./s.

Here the duration d₁ has been chosen to be equal to 0.6 s. To this end the wire is removed from the furnace and then kept in air at ambient temperature for one second. In fact, under these conditions approximately 0.4 s is required for the temperature of the wire to go from 600° C. to 559° C. Thus, the wire is maintained at a temperature between 559° C. and 350° C. inclusive for 0.6 s. In this case at the end of the duration d₁ the temperature of the surface layer is approximately 500° C. and therefore much higher than 350° C.

At the end of step 90, the lamellar texture 40 is formed inside the layer 18. However, as explained above, at this stage this lamellar texture is not stable.

The object of step 92 is to fix the lamellar texture 40 obtained after step 90 and therefore to obtain it in a metastable state at ambient temperature. To this end, immediately after step 90 and during step 92, the wire is subjected to rapid cooling for a duration d₂ that causes the temperature of the lamellar texture 40 to fall suddenly below 30° C.

This second cooling is referred to as rapid because the duration d₂ is twice and typically ten times or fifty times shorter than the duration d₁. The duration d₂ is less than 0.05 s and most often less than 0.03 s.

To obtain a duration d₂ this short the speed of cooling during step 92 is much higher than during step 90. This speed of cooling is typically greater than 10 000° C./s during step 92. For example, here at the end of the duration d₁ the wire is quenched in water at ambient temperature. In this case, the speed of cooling during step 92 is of the order of 20 000° C./s and the duration d₂ is approximately 0.02 s.

After step 92, the lamellar texture 40 is in a metastable state and therefore does not perceptibly vary further as long as the wire is kept at ambient temperature.

Then, during a step 94, the wire obtained at the end of step 92 is drawn to obtain the electrode wire 2. This wire drawing step 94 enables the diameter of the electrode wire to be brought to the required diameter, which is to say here, a diameter of 250 μm. Step 94 fractures the layers 16 and 18. Thus, it is during this step 94 that most of the fractures situated in the layers 16 and 18 are created.

### Chapter III: Variants

### Variants of the Method of Manufacture

Many other methods of manufacturing the wire 2 are possible. For example, the method of manufacture described in chapter II can be implemented using a wire blank that is not necessarily made entirely of copper. For example, the wire blank instead includes only a surface layer in which the concentration of copper is greater than 50 atomic percent or 60 atomic percent and less than 95 atomic percent or 90 atomic percent. Likewise, it can also be implemented with a coating in which the zinc concentration is less than 100 atomic percent. Nevertheless, the zinc concentration of the coating is preferably high, that is to say greater than 95 atomic percent or 98 atomic percent.

There exist various methods for obtaining the delta phase copper-zinc alloy layer that is then cooled a first time during step 90, followed by a second time during step 92. For example, in accordance with a first variant the procedure for obtaining this delta phase copper-zinc alloy layer is as follows:
depositing a layer of nickel approximately 5 μm thick on the surface of the wire blank; and
dipping this wire blank coated with nickel in a bath of molten copper and zinc having a zinc concentration between 72 atomic percent and 77 atomic percent inclusive, the remainder being copper, and allowing the latter to diffuse at a temperature between 559° C. and 700° C. inclusive, preferably between 559° C. and 600° C. inclusive, more preferably equal to 600° C., in such a manner as to create the delta phase copper-zinc alloy surface layer that is stable as long as its temperature is maintained between 559° C. and 700° C.

In accordance with a second variant the procedure is as follows:
depositing on the surface of the wire blank a layer of nickel approximately 5 μm thick; and
co-extruding this wire blank coated with nickel with an alloy of copper and zinc having a zinc concentration between 72 atomic percent and 77 atomic percent inclusive and maintained at a temperature between 559° C. and 700° C. inclusive, preferably equal to 600° C., in such a manner as to create the delta phase copper-zinc alloy surface layer that is stable on this wire blank coated with nickel as long as the temperature is equal to 600° C.

In accordance with a third variant the procedure is as follows:
depositing on the surface of the metal wire blank a layer of nickel approximately 5 μm thick;
depositing on the layer of nickel a layer of copper and then a layer of zinc in proportions of copper and zinc between 72 atomic percent and 77 atomic percent inclusive of zinc with an excess of zinc chosen to compensate the inevitable evaporation of some of the zinc during the subsequent diffusion step; and
leaving the latter to diffuse at a temperature between 559° C. and 700° C. inclusive, preferably between 559° C. and 600° C. inclusive, or preferably equal to 600° C., in such a manner as to create the delta phase copper-zinc alloy surface layer.

In accordance with a fourth variant the procedure is as follows:
depositing on the wire blank by aqueous phase electrodeposition a coating of copper and zinc the composition of which is that of the delta phase; and
heating the wire to a temperature between 559° C. and 700° C. inclusive, preferably between 559° C. and 600° C. inclusive, more preferably between 595° C. and 600° C. inclusive in such a manner as to create the delta phase copper-zinc alloy surface layer.

In practice for aqueous phase electrodeposition of the coating of copper and zinc the composition of which is that of the delta phase, the wire blank constitutes the cathode and an anode is used made, for example, of copper-zinc alloy in which the zinc concentration is between 72 atomic percent and 77 atomic percent, that is to say an appropriate mixture of gamma and epsilon phases at ambient temperature. The electrolysis bath is adapted to deposit a coating the composition of which is that of the delta phase, preferably with 76% zinc in the deposit. For example, such a bath may contain:
water as solvent,
9 g per liter of copper cyanide CuCN,
70 g per liter of zinc cyanide Zn(CN)2,
125 g per liter of sodium cyanide NaCN, and
81 g per liter of potassium hydroxide KOH,
at a temperature from 20° C. to 80° C., and
with a current density from 1 A/dm2 to 10 A/dm2.

The advantage of electrodeposition of a copper-zinc alloy is that its composition is constant within the thickness of the coating, in contrast to diffusion of zinc on a copper or brass substrate, which has a composition gradient in the absence of a barrier layer.

The wire drawing step 94 may be omitted. In this case there are no fractures between the different textured zones. To the contrary, the lamellar texture extends continuously over all the periphery of the electrode wire.

Alternatively, the duration dᵢₙᵢ is chosen to be sufficiently long for an epsilon phase copper-zinc alloy surface layer to be formed on top of the delta phase copper-zinc alloy layer. In this case, after steps 90 and 92, the layer 18 with the lamellar texture is covered with a thin layer of epsilon phase copper-zinc alloy. Thus, in this case the layer 18 is not the surface layer of the electrode wire.

### Variants of the Electrode Wire:

The core of the electrode wire is not necessarily made of copper or an alloy including copper such as brass, for example. The core may also be made of steel or of another electrically conductive metal, for example. If the core does not include copper the delta phase copper-zinc alloy surface layer is obtained differently. For example, it may be produced in accordance with any of the first to fourth variants of the method of manufacture described hereinabove.

The layers 14 and 16 may be omitted. This is the case, in particular, if the delta phase copper-zinc alloy surface layer is not obtained using a method in which the copper of the central core diffuses into the zinc coating. The first to fourth above variants of the method of manufacture are examples of such methods of manufacture that do not employ diffusion of copper from the central core into a zinc coating.

The core is not necessarily made of a single metal or a single metal alloy. Alternatively, the core includes a plurality of layers each made of a respective metal or metal alloy. For example, the core includes a central body made of copper or of steel coated with a layer of brass.

Alternatively, the layer 18 is uniform and therefore formed of a single textured zone that extends continuously over the entire perimeter of the core 10. For example, to manufacture this variant, during step 82, the wire electroplated with zinc is drawn to obtain directly the required final diameter and the wire drawing step 94 is omitted. The other steps of the method from FIG. 5 remain unchanged, for example.

### Chapter IV: Advantages of the Embodiments Described

It has been observed that during its passage in the machining zone of an electrical discharge machining machine in which an electrical discharge machining process is employed the exterior face of the electrode wire generally receives a plurality of successive sparks. A result of this is that after a first spark affecting the exterior face of the electrode wire a later spark is produced on the exterior face that has been modified by the first spark and the other intermediate sparks. In other words, the sparks progressively modify the exterior face of the electrode wire, which can affect the efficacy of later sparks, in particular where the speed of the electrical discharge is concerned. In particular, the sparks locally modify the topography of the coating of the electrode wire by melting the material, which may flow. For example, in the case of the electrode wire from U.S. Pat. No. 8,067,689 it is, in particular, the melting of the epsilon phase copper-zinc alloy that modifies the topography of the coating because the epsilon phase has a melting point lower than that of the gamma phase.

To preserve a surface layer of the electrode wire having good erosion efficacy throughout its passage in the machining zone during electrical discharge machining it is proposed here to reduce as much as possible the degradation of that efficacy by the successive machining sparks. In this way the exterior face of the coating of the electrode wire can retain good erosion efficacy during a longer part of its travel in the machining zone in which the electrical discharge sparks are produced.

Compared to the electrode wire of U.S. Pat. No. 8,067,689 the surface layer of which includes gamma phase copper-zinc alloy islets embedded in the epsilon phase copper-zinc alloy, when the electrode wires described here are subjected to a machining spark that is intense and of short duration the textured zones produce less liquid. The craters resulting from the electrical discharge sparks then feature fewer re-solidified zones, for example. When the quantity of liquid produced is smaller, the electrode wire loses less material during the spark. It is therefore possible to reduce the speed at which the electrode wire moves and therefore the consumption of electrode wire while maintaining a good machining speed.

On the other hand, when the quantity of liquid produced is lower, there are fewer fractures or pores that are blocked by the flow of liquid with the result that the surface topography of the electrode wire is better preserved. The machining speed is therefore increased.

The improved performance of the electrode wire described here is currently explained by the fact that the epsilon phase copper-zinc alloy present in the layer 18 is wedged between the lamellae of the lamellar texture 40. When the epsilon phase copper-zinc alloy melts that alloy is then retained inside the interstices by the lamellae of the lamellar texture 40 since the melting point of the gamma phase copper-zinc alloy lamellae is higher than the melting point of the epsilon phase copper-zinc alloy.

The fact that the layer 18 is moreover the surface layer of the electrode wire enables exploitation of the properties of the lamellar texture 40 from the very beginning of electrical discharge machining process.

1. An electrode wire for electrical discharge machining, said electrode wire including:
a metal core, and
on the metal core a coating comprising one or more textured zones of copper-zinc alloy, each of said textured zones being formed exclusively by an entanglement of gamma phase copper-zinc alloy and epsilon phase copper-zinc alloy,
wherein inside each textured zone of copper-zinc alloy the majority of the gamma phase copper-zinc alloy is in the form of a lamellar texture in which the interstices between the lamellae consisting of gamma phase copper-zinc alloy are filled by the epsilon phase copper-zinc alloy.

2. The electrode wire as claimed in claim 1 in which the coating includes a first layer of copper-zinc alloy that extends over the entire periphery of the core, each textured zone of copper-zinc alloy being situated inside this first layer.

3. The electrode wire as claimed in claim 2 in which the first layer forms the surface layer of the electrode wire with the result that each textured zone of copper-zinc alloy is flush with the exterior face of the electrode wire.

4. The electrode wire as claimed in claim 2 in which the first layer includes fractures which in a cross section of the electrode wire mechanically separate the various textured zones of copper-zinc alloy.

5. The electrode wire as claimed in claim 1, in which the coating comprises successively from the core to the exterior of the electrode wire:
a second, homogeneous layer of copper-zinc alloy formed exclusively by gamma phase copper-zinc alloy, and
the first layer formed directly on the second layer.

6. The electrode wire as claimed in claim 1, in which the thickness of the first layer of copper-zinc alloy is greater than 2 μm and the greatest width in a cross section of the electrode wire of each textured zone of copper-zinc alloy is greater than 5 μm.

7. The electrode wire as claimed in claim 1, in which:
each lamella of the lamellar texture extends in a cross-section of the electrode wire mainly along a respective median trajectory, and
for most of the lamellae of the lamellar texture the mean thickness of the lamella along its median trajectory is less than 1 μm or 0.5 μm.

8. The electrode wire as claimed in claim 7 in which the maximum width of most of the interstices between two lamellae is less than 1 μm or 0.5 μm.

9. A method of manufacturing an electrode wire conforming to claim 1, wherein this method includes the following steps:
a) producing on a metal wire blank a coating having the capacity to form a delta phase copper-zinc alloy layer when its temperature is between 559° C. and 700° C. inclusive, then
b) heating said coating to a temperature between 559° C. and 700° C. inclusive and maintaining the coating at that temperature until a delta phase copper-zinc alloy layer is obtained, then
c) as soon as the delta phase copper-zinc alloy layer is obtained, carrying out a first cooling that maintains the temperature of this copper-zinc alloy layer that was in the delta phase at a temperature below 559° C. and greater than 350° C. during a duration d₁ between durations d₁ₘᵢₙ and d₁ₘₐₓ, where:
the duration d₁ₘᵢₙ is the minimum duration during which the temperature of the delta phase copper-zinc alloy must be maintained between 559° C. and 350° C. so that:
some of the delta phase copper-zinc alloy is transformed into gamma phase copper-zinc alloy and forms a lamellar texture of gamma phase copper-zinc alloy that contains most of the gamma phase copper-zinc alloy, and
in parallel with this, the remainder of the delta phase copper-zinc alloy is transformed into epsilon phase copper-zinc alloy that fills the interstices between the lamellae of the gamma phase copper-zinc alloy lamellar texture, and
the duration d₁ₘₐₓ is the duration beyond which the lamellar texture copper-zinc alloy disappears to give way to a sub-layer 90% of the weight of which is formed by gamma phase copper-zinc alloy, then
d) immediately after the duration d₁ has elapsed carrying out a second cooling that reduces the temperature of the lamellar texture to 30° C. in less than 0.05 s.

10. The method as claimed in claim 9 in which the duration d₁ₘᵢₙ is greater than or equal to 0.1 s and the duration d₁ₘₐₓ is less than or equal to 1.5 s.

11. The method as claimed in claim 9, in which:
the copper concentration on a surface layer of the wire blank is greater than 50 atomic percent or 60 atomic percent, and
producing the coating includes producing directly on this surface layer of the wire blank a layer the zinc concentration of which is greater than 98 atomic percent.

12. The method as claimed in claim 11 in which step b) consists in placing the wire blank on which the coating has been produced in a furnace at 600° C. for 6 s.
